(19) United States
(12) Patent Application Publication
(10) Pub. No.: US 2025/0158082 A1
(43) Pub. Date: May 15, 2025

(54) MANUFACTURING METHOD OF CATALYST FOR FUEL CELL

(71) Applicants: Hyundai Motor Company, Seoul (KR); Kia Corporation, Seoul (KR)

(72) Inventors: Young Jung Heo, Hwaseong-si (KR); Hee Su Yang, Yongin-si (KR)

(21) Appl. No.: 18/750,636

(22) Filed: Jun. 21, 2024

(30) Foreign Application Priority Data
Nov. 10, 2023 (KR) 10-2023-0155178

(51) Int. Cl. H01M 4/90; H01M 8/10

(52) U.S. Cl. CPC H01M 4/9083; H01M 2008/1095

(57) ABSTRACT

A method of manufacturing a fuel cell catalyst can include a method of manufacturing a carbon carrier for a fuel cell catalyst, in which the carbon carrier can have an improved binding force to a catalytic metal and improved carbon durability. The carbon carrier can be coated with a carbon layer highly doped with heteroatoms. The carbon layer can be formed by uniformly compounding a conductive polymer containing the heteroatoms with the carbon carrier and heat-treating the compounded mixture.

### CROSS-REFERENCE TO RELATED APPLICATIONS

The present application claims priority to Korean Patent Application No. 10-2023-0155178, filed Nov. 10, 2023, the entire contents of which is incorporated herein for all purposes by this reference.

### TECHNICAL FIELD

The present disclosure relates to a method of manufacturing a catalyst for a fuel cell.

### BACKGROUND

In a proton exchange membrane fuel cell (PEMFC), an electrode-catalyst layer is composed of a carbon carrier supporting platinum (Pt) or the like and an ionomer used as a binder. Platinum and alloy catalysts used as fuel cell catalysts, which are configured such that platinum or alloy particles loaded onto a carbon carrier, play the most important role in cell performance and durability, and the performance of the catalysts is greatly influenced by the structure and properties of the catalytic particles and the carbon carrier. Therefore, it is extremely urgent and important to develop optimized catalysts to ensure the performance and durability of hydrogen electric vehicles.

In the fuel cell catalysts, the carbon carrier acts as an electron conductor to deliver electrons to the catalytic particles and as a support for the dispersion of the catalytic nanoparticles to enhance catalytic activity. Accordingly, the physical properties required for the carbon carrier are (1) high electrical conductivity to improve electron transport efficiency, (2) high porosity to evenly distribute catalysts of several nanometers and reduce mass transfer resistance in a high current density region, (3) high durability against carbon corrosion that may occur during fuel cell operation, and (4) carbon surface properties to improve catalyst dispersion and catalyst-carrier bonding.

In particular, the durability of carbon carriers can be improved by increasing the graphitic degree of the carbon surface and the thickness of the carbonization layer. In general, the increase in graphitic degree is limited because it can only be increased by high-temperature heat treatment of above 2,000° C., and the surface of carbon materials with the graphitized structure has a high hydrophobicity, so the bonding strength between the carrier and the catalyst particles is weak when the catalyst particles are loaded.

In addition, to solve the problem of platinum elution and durability deterioration of the Pt catalyst during fuel cell operation, it is very important to control the surface of the carbon carrier to improve the interfacial attraction between the catalytic particles and the carbon carrier. For this purpose, various methods have been researched and studied, such as: a method of doping the surface of a carbon carrier with heteroatoms such as B, N, S, and P; carbon surface treatment such as plasma and ozone treatments; and introduction of nanometallic particles. However, the technology level is still low.

### SUMMARY

To develop a next-generation carbon carrier that satisfies both durability and improved performance, a new synthesis strategy that can balance between the required properties is needed. The present disclosure relates to a method of manufacturing a catalyst for a fuel cell and specifically provides a carbon carrier with improved binding to a catalytic metal and improved carbon durability, in which the carbon carrier is coated with a carbon layer highly doped with heteroatoms, and the carbon layer is formed by uniformly compounding a conductive polymer containing the heteroatoms with the carbon carrier and heat-treating the resulting mixture.

Some embodiments of the present disclosure can solve the problems occurring in the related art and provides a method of improving a binding force between a catalytic metal and a carbon carrier by forming a carbonized layer on the surface of a carbon material from a precursor polymer containing a heteroatom. In particular, some embodiments of the present disclosure aim at achieving improvement of durability against platinum elution and ensuring durability of a carbon carrier.

The advantages of the present disclosure are not necessarily limited to the advantages described above. The above and other advantages of the present disclosure can become more apparent from the following description and can be realized by embodiments, as recited in the claims and various combinations of the embodiments.

According to an embodiment of the present disclosure, a method of manufacturing a fuel cell catalyst can include: synthesizing a precursor polymer; preparing a carrier dispersion containing the precursor polymer and a carbon material; preparing an intermediate having a configuration in which a surface of the carbon material is coated with the precursor polymer; immobilizing the precursor polymer on the surface of the carbon material by performing primary heat treatment on the intermediate; preparing a carbon carrier by converting the precursor polymer into a carbonized layer by performing secondary heat treatment on the intermediate; and introducing a catalytic metal into the carbonized layer to produce a catalyst. The carbonized layer can contain at least one heteroatom selected from the group consisting of sulfur(S), nitrogen (N), phosphorus (P), and combinations thereof.

In an embodiment, the precursor polymer may include a conductive polymer.

In an embodiment, the synthesizing of the precursor polymer may include introducing a polymeric raw material and an initiator into a first organic solvent to prepare a precursor dispersion, and may involve a process in which an initiation reaction occurs with the polymeric raw material dissolved in the precursor dispersion and a polymerization reaction proceeds.

The polymerization reaction may involve a process of stirring the precursor dispersion, and the stirring may be carried out at a temperature in the range of 0° C. to 80° C. for a period of 3 hours to 48 hours.

In an embodiment, the method may further include washing and drying both of which are performed after the stirring.

In an embodiment, the polymeric raw materials may include at least one selected from the group consisting of nitrogen-containing organic materials, sulfur-containing organic materials, nitrogen-containing and sulfur-containing organic materials, phosphorus-containing organic materials, and polymers thereof.

Specifically, the nitrogen-containing organic materials may include at least one selected from the group consisting of pyrrole, guanine, adenine, purine, melamine, urea, pyridine, aniline, dicyandiamide, ethylenediamine, ethylenediaminetetraacetic acid (EDTA), and combinations thereof.

The sulfur-containing organic materials may include at least one selected from the group consisting of benzyl disulfide, thiophene, 2,2-dithiophene, p-toluenesulfonic acid, 2-thiophenemethanol, and combinations thereof.

The phosphorus-containing organic materials may include at least one selected from the group consisting of phytic acid, phytate, sodium hypophosphate, phosphoric acid, hexachlorophosphazene acid, and combinations thereof.

The nitrogen-containing and sulfur-containing organic materials may include at least one selected from the group consisting of thiourea, ammonium thiocyanate, thioacetamide, and combinations thereof.

In an embodiment, the initiator may include at least one selected from the group consisting of iron chloride (FeCl₃), ammonium persulfate ((NH₄)₂S₂O₈), zinc chloride (ZnCl₂), hydrogen peroxide (H₂O₂), potassium permanganate (KMnO₄), sodiumdichromate (Na₂Cr₂O₇), and combinations thereof.

In an embodiment, the precursor dispersion may contain 0.1 to 10 equivalents of the initiator.

In an embodiment, the carbon material may include at least one selected from the group consisting of activated carbon, Carbon black, carbon nanotube, graphene, and combinations thereof.

In an embodiment, the carbon material may have mesopores, and the mesopores may have an average diameter of from 2 nm to 50 nm.

In an embodiment, the carrier dispersion may be prepared by at least one method selected from the group consisting of ultrasonic dispersion, stirring, hydraulic high pressure homogenization, and combinations thereof.

The hydraulic high pressure homogenization may include the step of preparing a fluid including the precursor polymer the carbon, and a second organic solvent and the step of performing at least one time a process of adjusting the pressure of the fluid to 100 to 3,500 bar_{g} and passing the fluid through a nozzle having a diameter of 50 μm to 200 μm at a flow rate of 100 to 2,000 ml/min to disperse the carbon material.

In an embodiment, the intermediate may include 30 to 150 parts by weight of the precursor polymer, based on 100 parts by weight of the carbon material.

In an embodiment, the primary heat treatment may be performed in an inert atmosphere at a temperature in a range of ±50° C. relative to the melting point Tm of the precursor polymer for a period of 0.1 to 5 hours.

In an embodiment, the primary heat treatment may be performed in an inert atmosphere at a temperature in a range of 200° C. to 300° C. for a period of 0.1 to 5 hours.

In an embodiment, the secondary heat treatment may be performed at a temperature in a range of 600° C. to 1,200° C. for a period of 1 to 12 hours.

In an embodiment, the longitudinal crystal size (Lc) of the carbonized layer may be equal to or larger than 3 nm.

In an embodiment, the longitudinal crystal size (Lc) of the carbonized layer may be equal to or larger than 2.0 nm.

In an embodiment, the catalytic metal may include at least one selected from the group consisting of platinum (Pt), gold (Au), silver (Ag), rhodium (Rh), nickel (Ni), cobalt (Co), iron (Fe), palladium (Pd), copper (Cu), iridium (Ir), osmium (Os), molybdenum (Mo), vanadium (V), and combinations thereof.

In an embodiment, the catalytic metal may be contained in an amount of 10 to 50parts by weight, based on 100 parts by weight of the catalyst.

According to an embodiment of the present disclosure, a fuel cell catalyst can include: a carbon carrier including a carbon material and a carbonized layer covering at least a portion of a surface of the carbon material; and a catalytic metal uniformly dispersed in the carbonized layer. The carbonized layer can include at least one heteroatom selected from the group consisting of sulfur(S), nitrogen (N), phosphorus (P), and combinations thereof.

The catalytic metal may be uniformly dispersed on the carbonized layer through chemical bonding with the heteroatom.

In an embodiment, the carbonized layer may have a thickness of 3.0 nm or more. In addition, the carbonized layer may have a longitudinal crystal size (Lc) of 2.0 nm or more.

In an embodiment, the carbon material may have mesopores, and the mesopores may have an average diameter of 2 nm to 50 nm. Here, the catalytic metal may be uniformly dispersed on an outer surface and an inner surface of the carbon material.

According to an embodiment of the present disclosure, a heteroatom-doped carbonized layer can be provided on the surface of a carbon material through primary and secondary heat treatment after a conductive polymer containing the heteroatom is compounded with a carbon carrier, thereby providing a carbon carrier with improved binding force to a catalytic metal and improved durability. Accordingly, the anchoring effect of strong bonding between the doped heteroatom and the catalytic metal can be induced to improve the catalyst binding force, and at the same time, the carbon layer on the surface of the carbon carrier can be enhanced to improve the carbon resistance against corrosion.

The advantages of the present disclosure are not necessarily limited to the ones described above. The advantages of the present disclosure can be understood to include advantages that can be inferred from the following description.

### BRIEF DESCRIPTION OF THE DRAWINGS

FIG. 1 is a diagram schematically illustrating an intermediate, according to an embodiment of the present disclosure;

FIG. 2 is a diagram schematically illustrating an intermediate including a mesoporous carbon material, according to an embodiment of the present disclosure;

FIG. 3 is a diagram schematically illustrating a carbon carrier, according to an embodiment of the present disclosure;

FIG. 4 is a diagram schematically illustrating a carbon carrier containing a mesoporous carbon material, according to an embodiment of the present disclosure;

FIG. 5 is a diagram schematically illustrating an intermediate, according to an embodiment of the present disclosure;

FIG. 6 is a diagram schematically illustrating a catalyst including a mesoporous carbon material, according to an embodiment of the present disclosure;

FIG. 7 is a diagram schematically illustrating the crystal structure of carbon, according to an embodiment of the present disclosure;

FIG. 8 shows the results of S₂ₚ XPS for Example 1, Comparative Example 1, and Comparative Example 2, according to an embodiment of the present disclosure;

FIG. 9 is a transmission electron microscope (TEM) image for Example 1, according to an embodiment of the present disclosure;

FIG. 10 shows the results of energy dispersive X-ray spectroscopy (EDS) analysis for Example 1, according to an embodiment of the present disclosure;

FIG. 11 is TEM images for Example 1, according to an embodiment of the present disclosure;

FIG. 12 is TEM images for Example 2, according to an embodiment of the present disclosure;

FIG. 13 shows the results of XRD analysis for Example 1 and Comparative Example 1, according to an embodiment of the present disclosure;

FIG. 14 shows the results of 77K/N₂ gas adsorption analysis for Example 1 and Comparative Example 1, according to an embodiment of the present disclosure;

FIG. 15 shows the results of porosity analysis for Example 1 and Comparative Example 1, according to an embodiment of the present disclosure;

FIG. 16 shows durability test conditions for membrane electrode assemblies (MEAs) to which Example 6 and Comparative Example 4 are applied, according to an embodiment of the present disclosure;

FIG. 17 illustrates the electrochemical performance before and after a durability test of each of the MEAs to which Example 6 and Comparative Example 4 are applied, according to an embodiment of the present disclosure; and

FIG. 18 shows the deterioration rate before and after a durability test of each of the MEAs to which Example 6 and Comparative Example 4 are applied, according to an embodiment of the present disclosure.

### DETAILED DESCRIPTION OF ILLUSTRATIVE EMBODIMENTS

Above and other features and advantages of the present disclosure will be readily understood from the following example embodiments associated with the accompanying drawings. However, an embodiment of the present disclosure is not necessarily limited to the example embodiments described herein and may be embodied in other forms. The example embodiments described herein are provided so that the disclosure can be made thorough and complete and that the spirit of the present disclosure can be fully conveyed to those skilled in the art.

Throughout the drawings, like elements can be denoted by like reference numerals. In the accompanying drawings, the dimensions of the structures are larger than actual sizes for clarity of the present disclosure. Terms used in the specification, “first”, “second”, etc., may be used to describe various components, but the components are not to be construed as being necessarily limited by such terms. Such terms can be used for the purpose of distinguishing a component from another component. For example, without departing from the scope of the present disclosure, a first component may be referred to as a second component, and a second component may be also referred to as a first component. As used herein, the singular forms “a”, “an”, and “the” can be intended to include the plural forms as well unless the context clearly indicates otherwise.

It can be further understood that the terms “comprises”, “includes”, “containing”, or “has” when used in this specification specify the presence of stated features, regions, integers, steps, operations, elements and/or components, but do not preclude the presence or addition of one or more other features, regions, integers, steps, operations, elements, components and/or combinations thereof. It can also be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein can be taken as approximations including various uncertainties affecting measurement that inherently occur in obtaining these values, among others, and thus can be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In this specification, when a range is described for a variable, the variable can be understood to include all values within the described range, including the described endpoints of the range. For example, the range “5 to 10” can be understood to include not only the values 5, 6, 7, 8, 9, and 10, but also any subrange thereof, such as 6 to 10, 7 to 10, 6 to 9, 7 to 9, and any value between integers that fall within the categories of the stated range, such as 5.5, 6.5, 7.5, 5.5 to 8.5, and 6.5 to 9. It can also be understood that, for example, the range of “10% to 30%” includes values such as 10%, 11%, 12%, 13%, and all integers up to and including 30%, as well as arbitrary subranges such as 10% to 15%, 12% to 18%, 20% to 30%, and arbitrary values between reasonable integers within the categories of the stated range, such as 10.5%, 15.5%, 25.5%, etc.

### Method of Manufacturing Fuel Cell Catalyst

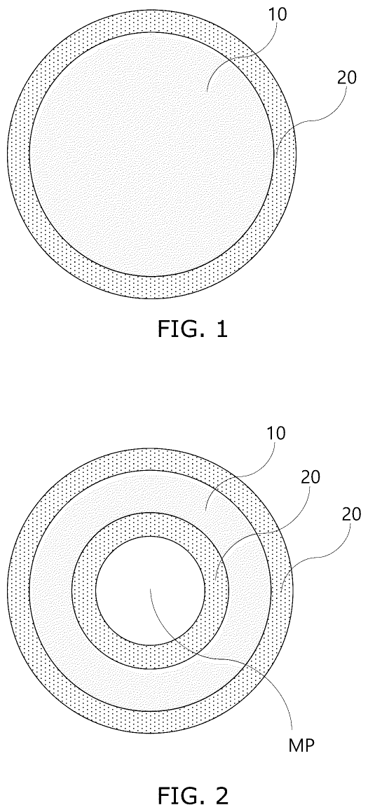

FIG. 1 is a diagram schematically illustrating an intermediate, according to an embodiment of the present disclosure.

A fuel cell catalyst manufacturing method according to an embodiment of the present disclosure can include: synthesizing a precursor polymer 20; preparing a carrier dispersion containing the precursor polymer 20 and a carbon material 10; preparing an intermediate having a configuration in which the surface of the carbon material 10 is coated with the precursor polymer 20; immobilizing the precursor polymer 20 on the surface of the carbon material 10 by performing primary heat treatment on the intermediate; preparing a carbon carrier by converting the precursor polymer 20 into a carbonized layer 20′ by performing secondary heat treatment on the intermediate; and introducing a catalytic metal 30 into the carbonized layer 20′ to produce a catalyst. The carbonized layer 20′ can contain one type of heteroatom selected from the group consisting of sulfur(S), nitrogen (N), phosphorus (P), and combinations thereof.

The fuel cell catalyst obtained by the manufacturing method may have the carbonized layer 20′ doped with more heterogeneous atoms than conventional fuel cell catalysts. Therefore, in an embodiment, it is possible to improve both the binding force between the catalytic metal 30 and the carbon carrier and the durability of the carbon carrier.

Hereinafter, the manufacturing method of an embodiment will be described in greater detail.

The step of synthesizing the precursor polymer may include the step of dissolving a polymeric raw material from which the precursor polymer 20 is derived in a first organic solvent. The polymeric raw materials may include one selected from the group consisting of nitrogen-containing organic materials, sulfur-containing organic materials, nitrogen-and sulfur-containing organic materials, phosphorus-containing organic materials, and polymers thereof.

The nitrogen-containing organic materials may include one selected from the group consisting of pyrrole, guanine, adenine, purine, melamine, urea, pyridine, aniline, dicyandiamide, ethylenediamine, ethylenediaminetetraacetic acid (EDTA), and combinations thereof.

The sulfur-containing organic materials may include one selected from the group consisting of benzyl disulfide, thiophene, 2,2-dithiophene, p-toluenesulfonic acid, 2-thiophenemethanol, and combinations thereof.

The nitrogen-and sulfur-containing organic materials may include one selected from the group consisting of thiourea, ammonium thiocyanate, thioacetamide, and combinations thereof.

The phosphorus-containing organic materials may one selected from the group consisting of phytic acid, phytate, sodium hypophosphate, phosphoric acid, hexachlorophosphazene, etidronic acid, and combinations thereof.

In an example embodiment, the first organic solvent is not particularly limited as long as it is capable of dissolving the polymeric raw material. For example, an aromatic organic solvent such as methylene chloride, benzene, toluene, etc. or a non-polar organic solvent may be used.

Next, the precursor dispersion can be prepared by adding an initiator to the first organic solvent in which the polymeric raw material is dissolved. Examples of the initiator may include one selected from the group consisting of iron chloride (FeCl₃), ammonium persulfate ((NH₄)₂S₂O₈), zinc chloride (ZnCl₂), hydrogen peroxide (H₂O₂), potassium permanganate (KMnO₄), sodium dichromate (Na₂Cr₂O₇), and combinations thereof.

The precursor dispersion may contain 0.1 to 10 equivalents of the initiator based on the precursor polymer. When the amount of the initiator is less than 0.1 equivalents, the reaction rate can be low, and the degree of polymerization may be insignificant. When the amount of the initiator is more than 10 equivalents, it can be difficult to control the polymerization rate, resulting in decrease in efficiency.

Next, an initiation reaction may take place in the precursor dispersion containing the first organic solvent, the polymer raw material, and the initiator, so that a polymerization reaction proceeds. Specifically, the precursor dispersion may be stirred at 0° C. to 80° C. for 3 to 48 hours. When the stirring temperature for the precursor dispersion is below 0° C. or the stirring time is shorter than 3 hours, the polymerization may insufficiently occur. When the stirring temperature is above 80° C. or the stirring time is longer than 48 hours, the homogeneity of the polymer produced through the polymerization may be reduced, and the synthesis efficiency may be poor.

After the precursor dispersion is stirred and the polymerization is performed, the reaction product can undergo filtering, washing, and drying. Thus, a precursor polymer can be obtained. The washing may be performed at least two times, and each time the reaction product can be washed with acetone and then with ethanol. The drying can be performed in a vacuum oven at a temperature in the range of 60° C. to 100° C.

If the polymeric raw material containing heteroatoms is directly applied on the surface of the carbon material 10 unlike the way adopted in some embodiments of the present disclosure, because the polymeric raw material has a low boiling point and is thus highly volatile, the immobilization rate of the polymeric raw material to the surface of the carbon material 10 can be low, and thus the doping efficiency can be low.

According to an embodiment of the present disclosure, instead of directly doping the surface of the carbon material 10 with the heteroatoms, the heteroatoms can be introduced into the surface of the carbon material 10 using the precursor polymer 20 that is non-volatile. Therefore, in an embodiment, the amount of heteroatoms with which the surface of the carbon material 10 is doped can be greatly increased.

In an embodiment, the precursor polymer 20 may include a conductive polymer. When the precursor polymer 20 is a conductive polymer, it can be possible to improve the uniform coating and the surface immobilization rate of the carbon material 10 due to good carbon-polymer compatibility. Therefore, a conductive polymer can be suitably used for the precursor polymer 20. In addition, the π-π-interaction between the conjugated π-orbital of the conductive polymer and the π-orbital of the carbon material 10 can enhance the binding force, thereby improving the immobilization rate of the surface dopant. Of course, it is not intended to imply that the precursor polymer 20 is necessarily a conductive polymer.

After synthesizing the precursor polymer by the process described above, the carrier dispersion containing the precursor polymer 20 and the carbon material 10 may be prepared. The carrier dispersion may be prepared by at least one method selected from the group consisting of ultrasonic dispersion, stirring, a hydraulic high pressure homogenization, and combinations thereof. By dispersing the carrier dispersion using the methods, a uniform dispersion and increase in surface area of the precursor polymer 20 and carbon material 10 can be achieved.

In an embodiment, the hydraulic high pressure homogenization may include the step of preparing a fluid including the precursor polymer 20, the carbon material 10, and a second organic solvent, the step of adjusting the pressure of the fluid to 100 to 3,500 bar_{g}, and passing the fluid through a nozzle having a diameter of 50 μm to 200 μm at a flow rate of 100 to 2,000 ml/min to disperse the carbon material 10.

Referring to FIG. 1, with the use of the hydraulic high pressure homogenization, the precursor polymer 20 and the carbon material 10 can be more uniformly dispersed, and thus a carrier dispersion with an increased surface area can be obtained.

In an embodiment, the carrier dispersion may contain 5 to 300 parts by weight of the precursor polymer 20, based on 100 parts by weight of the carbon material 10. Preferably, the precursor polymer 20 may be contained in an amount of 30 to 150 parts by weight. When the precursor polymer 20 is contained in an amount of less than 30 parts by weight, a carbon carrier with a low heteroatom doping rate may be produced. When the precursor polymer 20 is contained in an amount of more than 150 parts by weight, the porosity of the carbon carrier may decrease due to an excessive heteroatom content.

Examples of the carbon material 10 may include one selected from the group consisting of activated carbon, Carbon black, carbon nanotube, graphene, and combinations thereof. The carbon material 10 has mesopores (MPs), and the mesopores (MPs) may have an average diameter of 2 nm to 50 nm.

FIGS. 2 and 4 schematically illustrate an intermediate including the carbon material 10 having mesopores (MP) formed therein. Referring to FIG. 6, as will be described later, the catalytic metal 30 may be introduced into the mesopores (MP) formed in the carbon material 10 of the carbon carrier. When the mesopores have an average diameter of less than 2 nm, there may not be sufficient space to accommodate the catalytic metal 30 in the carbon carrier. When the average diameter of the mesopores exceeds 50 nm, the specific surface area of the carbon material 10 can be reduced so that a little amount of the catalytic metal 30 can be introduced into the carbon carrier.

Referring to FIG. 2, after preparing the carrier dispersion as described above, a solvent removal process can be performed to produce an intermediate including the precursor polymer 20 applied on the surface of the carbon material 10. The solvent removal process may be an evaporation or drying process conventionally used to remove organic solvents. For example, a rotary evaporator can be used to remove the solvent from the carrier dispersion, and the solvent-free residual may be dried in a vacuum oven at a temperature of 60° C. to 100° C. to obtain an intermediate. Herein, the intermediate is described such that the surface of the carbon material 10 is coated, but the term “surface of the carbon material” may include the inner surface of the mesopores of the carbon material 10 as well as the outer surface of the carbon material 10 as illustrated in FIGS. 2, 4, and 6.

Next, the primary heat treatment may be performed on the intermediate to immobilize the precursor polymer 20 to the surface of the carbon material 10. In this case, the primary heat treatment may be performed in a temperature range of ±50° C. relative to the melting point Tm of the precursor polymer 20.

When the temperature for the primary heat treatment is lower than −50° C. relative to the melting point Tm of the precursor polymer 20, the precursor polymer 20 may not relax sufficiently and may undergo a small structural change, resulting in a small effect of immobilizing the precursor material 20 to the surface of the carbon material 10. When the temperature for the primary heat treatment is higher than +50° C. relative to the melting point Tm of the precursor polymer 20, the precursor polymer 20 may decompose or may undesirably carbonize.

The range of ±50° C. relative to the melting point Tm may vary depending on the type of the precursor polymer 20, but for example, the temperature for the primary heat treatment may be in the range of 200° C. to 300° C.

In addition, the primary heat treatment may be performed in an inert atmosphere for a period of from 0.1 hour to 5 hours. When the period for the primary heat treatment is shorter than 0.1 hour, the precursor polymer 20 may not relax sufficiently and may undergo a small structural change, resulting in a small effect of immobilizing the precursor material 20 to the surface of the carbon material 10. When the period for the primary heat treatment is longer than 5 hours, the precursor polymer 20 may decompose or undesirably carbonize.

On the other hand, the inert atmosphere can be formed with an inert gas, the type of which is not particularly limited, but for example, nitrogen (N₂) or an 18th group gas may be used.

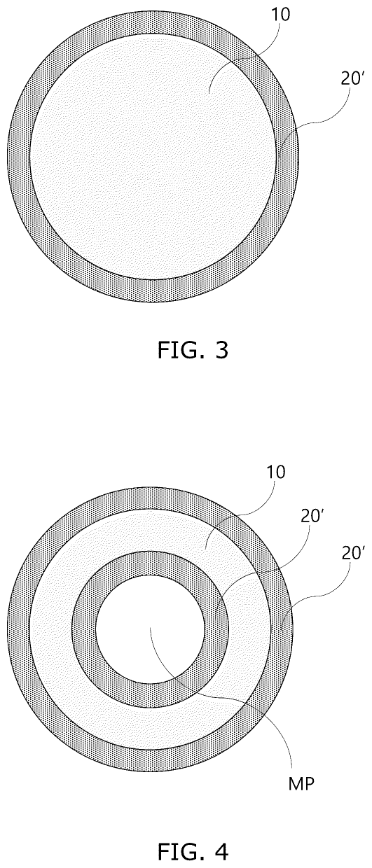

FIGS. 3 and 4 are schematic views of a carbon carrier according to one embodiment of the present disclosure and a carbon carrier including a carbon material 10 with mesopores (MP) according to one embodiment of the present disclosure.

After the precursor polymer 20 is immobilized on the carbon material 10 by the primary heat treatment, the secondary heat treatment may be performed. The precursor polymer 20 contained in the intermediate may be carbonized by the secondary heat treatment and converted into the carbonized layer 20′ as shown in FIGS. 2 and 4. Herein, the term “carbonization” may refer to the process by which functional groups contained in the precursor polymer 20 are removed and converted to carbon (C).

In an embodiment, the secondary heat treatment may be performed 600° C. to 1,200° C. for 1 to 12 hours. When the secondary heat treatment is performed at a temperature below 600° C. or for less than 1 hour, the carbonization effect may be reduced. When the secondary heat treatment is performed at a temperature above 1,200° C. or is performed for more than 12 hours, the heteroatoms may be removed, resulting in reduction in the doping effect.

The secondary heat treatment may be carried out in an inert atmosphere that is substantially the same as that described above, i.e., the same as the inert atmosphere for the primary heat treatment, so that redundant description will be omitted.

In an embodiment, the thickness of the carbonized layer 20′ formed by the secondary heat treatment may be 3 nm or more. The thickness of the carbonized layer 20′ may be observed with a microscope, for example, a transmission electron microscope (TEM) or a scanning electron microscope (SEM). When the thickness of the carbonized layer 20′ is less than 3 nm, the durability of the carbon carrier may be reduced.

The upper limit of the thickness of the carbonized layer 20′ is not particularly limited and may be, for example, 100 nm or less.

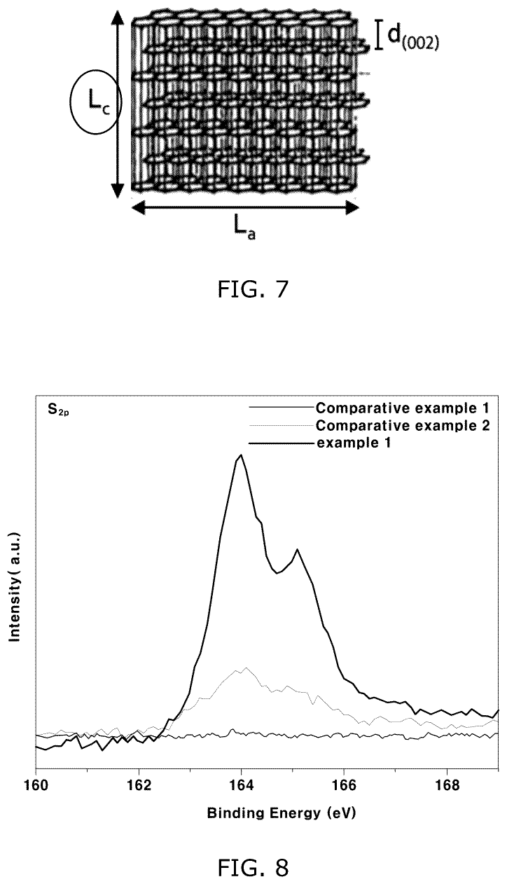

FIG. 7 is a reference view to illustrate the longitudinal crystal size of the carbonized layer 20′. In one embodiment, the longitudinal crystal size Lc of the carbonized layer 20′ may be greater than or equal to 2.0 nm.

The longitudinal crystal size Lc of the carbonized layer 20′ may be calculated by the Scherrer Equation. The Scherrer Equation is a formula that relates the size of microcrystals in a solid crystal to the peak width of a diffraction pattern, and can be written as Formula 1 below.

$$τ = \frac{K λ}{β cos θ} \qquad [ Formula 1 ]$$

where: τ is the average size of crystals, K: is the shape factor, λ is the X-ray wavelength, βis the half-width of maximum intensity peak, and θ is the X-ray incidence angle.

When the longitudinal crystal size of the carbonized layer 20′ is less than 2 nm, the durability of the carbon carrier may be reduced. The longitudinal crystal size of the carbonized layer 20′ is not particularly limited and may be, for example, 100 nm or less.

The carbonized layer 20′ according to an embodiment of the present disclosure can be formed from the precursor polymer 20. Therefore, the carbonized layer 20′ may contain one heteroatom selected from the group consisting of sulfur(S), nitrogen (N), phosphorus (P), and combinations thereof.

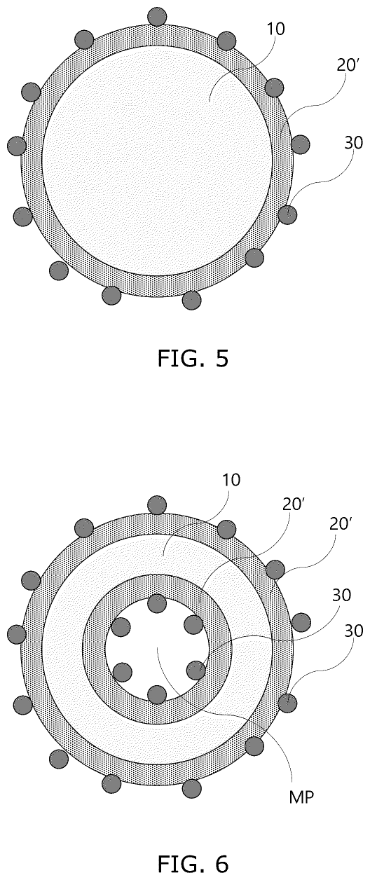

FIGS. 5 and 6 are schematic views of a catalyst having a catalytic metal 30 supported on a carbon carrier according to an embodiment of the present disclosure and a catalyst having a catalytic metal 30 supported on the inner and outer sides of a carbon carrier including a carbon material 10 having mesopores (MPs), according to an embodiment of the present disclosure.

After the carbon carrier is prepared through the secondary heat treatment, the catalytic metal 30 can be introduced into the carbon carrier to synthesize a catalyst for a fuel cell. Any method of introducing the catalytic metal 30 onto the carbon carrier can be used without limitation as long as the salt of the catalytic metal 30 can interact with the carbonized layer 20′ of the carbon carrier. For example, impregnation, polyol method, incipient wetness impregnation, and the like, can be used.

The heteroatoms doped on the carbonized layer 20′ can strongly interact with the catalytic metal 30, thereby improving the binding force and dispersion between the catalytic metal 30 and the carbon carrier (anchoring effect). Therefore, in an embodiment, although a fuel cell including the fuel cell catalyst is repeatedly charged and discharged, the catalytic metal 30 may not easily elute, and the elution durability can be improved.

In an embodiment, the catalytic metal may include one selected from the group consisting of platinum (Pt), gold (Au), silver (Ag), rhodium (Rh), nickel (Ni), cobalt (Co), iron (Fe), palladium (Pd), copper (Cu), iridium (Ir), osmium (Os), molybdenum (Mo), vanadium (V), and combinations thereof. Herein, the term “combination” may refer to an alloy of catalytic metals.

In an embodiment, the catalytic metal 30 may be contained in an amount of 1% to 99% by weight, based on the total weight of the catalyst. Preferably, the catalytic metal 30 may be contained in an amount of 10% to 50% by weight. When the amount of the catalytic metal 30 is less than 10% by weight, the density of the catalytic metal 30 in the catalyst may be low. When the amount of the catalytic metal 30 exceeds 50% by weight, the distance between the catalytic metal particles 30 is short, and the excessive amount of the catalytic metal 30 can make it difficult to induce bonding between the heteroatoms and the catalytic metal particles 30, which may reduce the durability of the catalyst.

Hereinafter, a fuel cell catalyst embodiment manufactured by the method embodiment described above will be described.

### Catalyst for Fuel Cell

A fuel cell catalyst according to an embodiment of the present disclosure can include: a carbon carrier including a carbon material 10 and a carbonized layer 20′ covering at least a portion of a surface of the carbon material 10; and a catalytic metal 30 uniformly dispersed in the carbonized layer 20′. The carbonized layer 20′ can contain at least one heteroatom selected from the group consisting of sulfur(S), nitrogen (N), phosphorus (P), and combinations thereof.

The carbonized layer 20′ containing the heteroatoms can be formed by preparing a carrier dispersion including the precursor polymer 20 and the carbon material 10, sufficiently dispersing the carrier dispersion by ultrasonic dispersion, stirring, or hydraulic high pressure homogenization to prepare an intermediate, and then performing the primary heat treatment and the secondary heat treatment on the intermediate. Therefore, the heteroatoms can be uniformly dispersed on the surface of the carbonized layer 20′. In this case, the heteroatoms doped on the carbonized layer 20′ can strongly interact with the catalytic metal 30, thereby improving the binding force and dispersion between the catalytic metal 30 and the carbon carrier (anchoring effect).

In an embodiment, because the fuel cell catalyst can be substantially the same as the catalyst prepared according to the fuel cell catalyst manufacturing method described above, redundant specific descriptions will be omitted.

Other forms in other embodiments of the present disclosure will be described in more detail with reference to the following examples. The following examples (i.e., example embodiments) are presented only to aid in understanding of the present disclosure and are not intended to necessarily limit the scope of the disclosure.

### Example 1

1) 0.84 g of thiophene as a polymeric raw material was dissolved in 100 mL of methylene chloride prepared as a first organic solvent. 9.72 g of iron chloride (FeCl₃) as an initiator was dissolved in 100 mL of acetonitrile, and this mixture was mixed with the first organic solvent in which thiophene was dissolved, thereby preparing a precursor dispersion. The precursor dispersion was reacted at 25° C. for 24 hours (polymerization reaction), and then the reaction mixture was filtered and washed with acetone and ethanol in sequence three times. The reaction product was dried in a vacuum oven at 80° C. to obtain a polymer precursor (Pth, polythiophene).

Here, since thiophene as a polymer raw material has a molecular weight of 84.14 g/mol, the number of moles of reaction becomes 0.01 mol. In addition, since the molecular weight of FeCl₃, which is an initiator, is 162.2 g/mol, the number of moles of reaction becomes 0.06 mol. Thus, the added initiator equivalent to the polymer raw material is 6.
2) 0.5 g of the precursor polymer (polythiophene) was added to 100 ml of tetrahydrofuran (THF) serving as a second organic solvent, and the mixture was stirred using a magnetic bar. 0.5 g of a carbon material 10 having mesopores (MPs) was added to the mixture, and the solution was sonicated for 30 minutes to prepare a carrier dispersion. The carrier dispersion was then stirred for 12 hours, and the second organic solvent was removed using a rotary evaporator. The dispersion from which the above second organic solvent was removed was dried in a vacuum oven at a temperature of 80° C. for 3 hours to prepare an intermediate.
3) The intermediate was subjected to primary heat treatment at 250° for 1 hour to obtain an intermediate having the precursor polymer 20 immobilized on the carbon material 10. The primary heat treatment was performed under argon (Ar) gas conditions.
4) The intermediate having undergone the primary heat treatment was subjected to secondary heat treatment at 800° C. for 3 hours to carbonize the precursor polymer 20. As a result, a carbon carrier having a carbonized layer 20′ formed on the carbon material 10 was synthesized. The secondary heat treatment was performed under argon (Ar) gas conditions.

### Example 2

A carbon carrier was synthesized in the same manner as in Example 1, except that 1.0 g of the precursor polymer (polythiophene) was added during the preparation of the carrier dispersion.

### Example 3

A carbon carrier was synthesized in the same manner as in Example 1, except that the secondary heat treatment was performed at 1000° C. for 3 hours.

### Example 4

A carbon carrier was synthesized in the same manner as in Example 1, except that polypyrrole was synthesized as the precursor polymer 20 by introducing pyrrole instead of thiophene during the synthesis of the precursor polymer 20.

### Example 5

1) 0.84 g of thiophene as a polymeric raw material was dissolved in 100 mL of methylene chloride prepared as a first organic solvent. 9.72 g of iron chloride (FeCl₃) as an initiator was dissolved in 100 mL of acetonitrile, and this mixture was mixed with the first organic solvent in which thiophene was dissolved, thereby preparing a precursor dispersion. The precursor dispersion was reacted at 25° C. for 24 hours (polymerization reaction), and then the reaction mixture was filtered and washed with acetone and ethanol in sequence three times. The reaction product was dried in a vacuum oven at 80° C. to obtain a precursor polymer (Pth, polythiophene).

In addition, polypyrrole was synthesized as the precursor polymer 20 by adding pyrrole instead of thiophene in the synthesis process of the precursor polymer 20.
2) A carbon carrier was synthesized in the same manner as in Example 1, except that polythiophene and polypyrrole were synthesized as the precursor polymer 20, and in the process of preparing the carrier dispersion, 0.5 g of the polythiophene, 1.0 g of the polypyrrole, and 1.0 g of the carbon material 10 were added.

### Example 6

A solution of catalytic metal 30 was prepared by dissolving catalytic platinum (Pt) in ethylene glycol, which is a solvent. Next, the synthesized carbon carrier was then added to the solution of the catalytic metal 30. Here, when the carbon carrier was 100 parts by weight, the catalytic platinum was 30 parts by weight. The solution containing the catalytic platinum and the carbon carrier was dried to obtain a fuel cell catalyst.

### Comparative Example 1

A mesoporous carbon material 10 which is not doped with heteroatoms using the precursor polymer 20 is prepared as a carbon carrier.

### Comparative Example 2

0.5 g of thiophene, which had not undergone a polymerization process, was mixed with 0.5 g of the mesoporous carbon material 10, and the mixture was then heat-treated at 800° C. for 3 hours to synthesize a carbon carrier having the carbon material 10 directly doped with heteroatoms(S). The secondary heat treatment was performed under argon (Ar) gas conditions.

### Comparative Example 3

Instead of synthesizing a carbon carrier in a wet manner by preparing an intermediate using a first organic solvent and a second organic solvent as in Example 1, a carbon carrier having a carbonized layer 20′ formed thereon was synthesized in a dry manner by injecting 1.0 g of thiourea and 1.0 g of a carbon material 10 into a planetary mill and performing heat treatment at 800° C. for 3 hours.

### Comparative Example 4

A fuel cell catalyst was synthesized in the same manner as in Example 6 above, except that 30 parts by weight of catalytic platinum (Pt) was introduced into the carbon carrier prepared according to Comparative Example 1 above.

### Experimental Example 1—Surface Composition Analysis Results

To determine the surface composition of each of the respective carbon carriers prepared according to Examples 1 to 5 and Comparative Examples 1 to 3, S2p XPS analysis was performed. The results are shown in FIG. 8 and Table 1.

TABLE 1

| Content of | Comparative | Comparative | Comparative | | | | | |
|---|---|---|---|---|---|---|---|---|
| element | Example | Example | Example | Example | Example | Example | Example | Example |
| (wt. %) | 1 | 2 | 3 | 1 | 2 | 3 | 4 | 5 |
| C | 97.5 | 97.3 | 94.1 | 92.9 | 90.7 | 96.5 | 92.4 | 80.7 |
| O | 2.4 | 2.0 | 5.4 | 4.8 | 3.7 | 2.6 | 4.7 | 11.8 |
| S | — | 0.6 | 0.4 | 2.3 | 5.6 | 0.9 | — | 1.8 |
| N | — | — | 2.2 | — | — | — | 3.0 | 5.7 |

Referring to Table 1 and FIG. 8, it can be seen that the peak intensity of Example 1 has a higher value than that of Comparative Example 2, which is a conventional art. That is, the higher value indicates a significant increase in the doping amount of heteroatom, sulfur(S), in the carbonized layer 20′. Furthermore, it is confirmed through Example 4 that doping of nitrogen (N) is also applicable, and it is confirmed through Example 5 that two or more types of heteroatoms can be doped.

### Experimental Example 2—Surface Structure and Composition Analysis through TEM and EDS

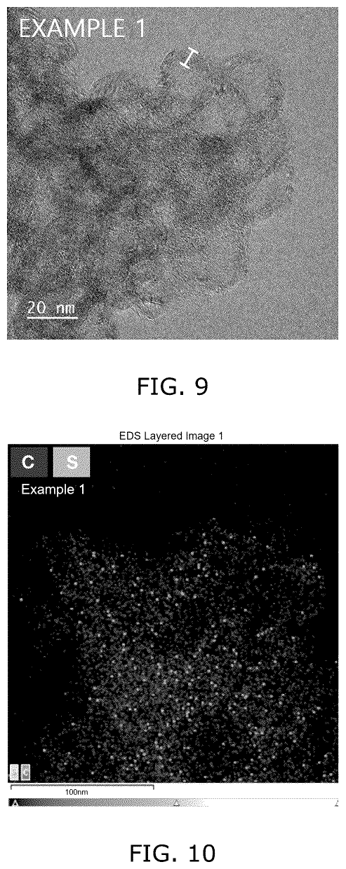

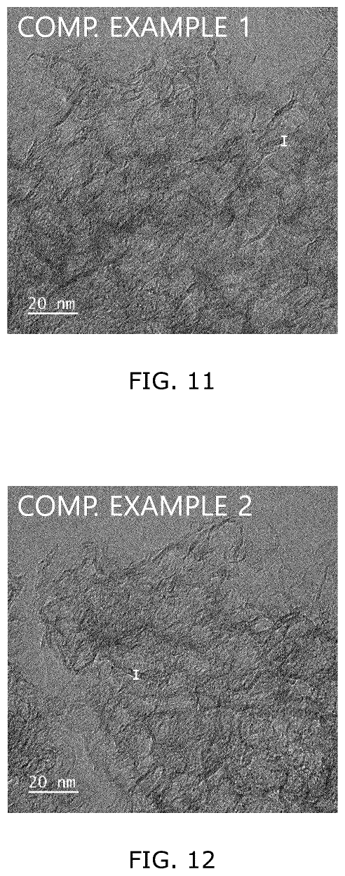

The carbon carrier synthesized according to Example 1 was imaged with TEM and EDS and are shown in FIGS. 9 and 10, respectively. The carbon carriers synthesized according to Comparative Example 1 and Comparative Example 2 are imaged with TEM and are shown in FIGS. 11 and 12, respectively.

To compare the doping content for the case where heteroatom doping is performed using the precursor polymer 20 and the doping content for the case where the heteroatom is directly introduced, the EDS analysis results of Example 1 and comparative Example 2 are shown in Table 2 below.

TABLE 2

| | Example 1 | | Comparative Example 2 | |
|---|---|---|---|---|
| Classification | Wt % | At % | Wt % | At % |
| C | 97.26 | 98.25 | 98.44 | 98.82 |
| O | 1.89 | 1.44 | 1.56 | 1.18 |
| S | 0.84 | 0.32 | 0.00 | 0.00 |
| Total | 100 | 100 | 100 | 100 |

Referring to FIG. 9, it can be seen that the average thickness of the carbonized layer 20′ formed on the surface of the carbon material 10 is about 3 nm or more. In addition, according to FIG. 10, it can be seen that the carbon carrier is uniformly doped with heteroelemental sulfur(S).

On the other hand, according to FIGS. 11 and 12, the thickness of the carbonized layer 20′ of the carbon carrier according to Comparative Examples 1 and 2 is less than 2 nm. In addition, according to Table 2 above, the doping amount of heteroelemental sulfur(S) in Comparative Example 2 was too small to be observed by an EDS image.

Example 1 shows a significant increase in graphite layer thickness (>3 nm) compared to conventional carbon, and the EDS results of Example 1 show that sulfur(S) is uniformly distributed. That is, the uniform doping can be achieved by the method of the present disclosure.

### Experimental Example 3—Surface Structure and Composition Analysis through XRD

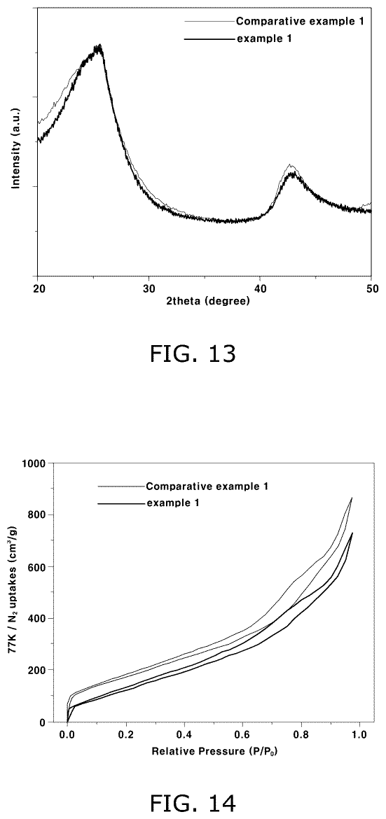

XRD was performed to analyze the structure of the carbonized layers 20′ of the respective carbon carriers. The value of Lc(002), which represents the longitudinal crystal size of the carbon contained in the carbonized layer 20′, was calculated through the Scherrer Equation. The results are shown in FIG. 13 and Table 3.

TABLE 3

| Classification | Lc(002)(nm) |
|---|---|
| Comparative Example 1 | 1.6 |
| Comparative Example 2 | 1.6 |
| Example 1 | 2.0 |
| Example 2 | 2.5 |

According to Table 3 above, Comparative Example 2 is a directly doped carbon sample (conventional art), and the thickness of the carbonized layer 20′ of Comparative Example 2 does not differ from that of a conventional carbon sample (Comparative Example 1). However, the thickness of the carbonized layer 20′ of Example 1 is increased by 2.0 nm. In addition, depending on the amount of the precursor polymer 20 added, the results of Example 2 show an increase of up to 2.5 nm.

### Experimental Example 4—Porosity Analysis

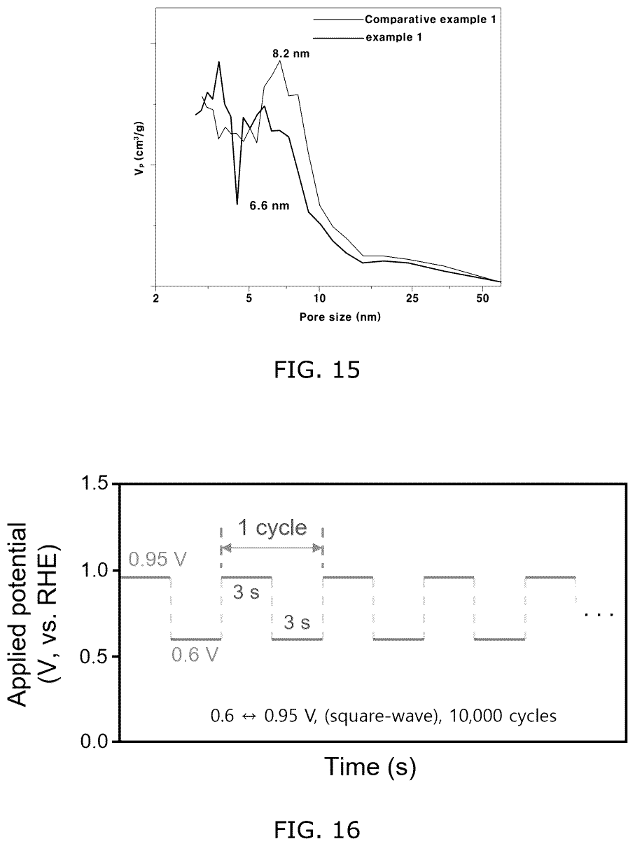

To analyze the surface porosity of the prepared carbon carriers, 77K/N2 gas adsorption analysis was performed on Example 1 and Comparative Example 1 above. The Brunauer-Emmett-Teller (BET) equation was used to calculate the specific surface area. The total pore volume was obtained by using an adsorption curve up to a relative pressure of 0.990, and the mesopore volume (Vmeso) was obtained by using the value of a desorption curve through the Barret-Joyner-Halenda (BJH) method. The mesoporosity was calculated by dividing the mesopore volume by the total pore volume and multiplying by 100 (percentage). The results are shown in FIG. 14, FIG. 15, and Table 4.

TABLE 4

| | S_{BET} | Vₘₑₛₒ | S content | |
|---|---|---|---|---|
| Samples | (m²/g) | (cm³/g) | (wt. %) | Lc(002)(nm) |
| Comparative Example 1 | 700 | 1.69 | — | 1.6 |
| Example 1 | 450 | 1.22 | 2.3 | 2.0 |
| Example 2 | 100 | 0.61 | 5.6 | 2.5 |

Comparative Example 1 is a typical mesoporous carbon material 10, characterized by the development of mesopores. Example 1 shows that porosity, including specific-surface area mesopores, is reduced by doping with heteroelemental sulfur(S) (including carbonization). This is because the carbonized layer 20′ formed on the surface of the carbon material 10 during the carbonization of the intermediate blocks the micropores of the carbon material 10 and thus reduces the specific surface area and strengthens the walls of the mesopores. This results in reduction in the size and volume of the mesopores.

When the amount of the polymer added is large as in Example 2, an amount of the heteroelemental sulfur(S) is confirmed to increase, but the porosity is confirmed to decrease. However, even though the porosity of the carbon carrier is reduced as in Example 2, because the doping amount of the heteroatom is relatively high compared to Example 1, the binding with catalytic platinum and the dispersion of catalytic platinum are improved. Therefore, it is anticipated that the catalyst durability performance and the cell performance may be similar between a membrane-electrode assembly (MEA) including the catalyst of Example 1 and an MEA including the catalyst of Example 2.

### Experimental Example 5—Analysis of Cell Performance of MEA and Catalyst Durability Performance

Nafion (DuPont Company) as an electrolyte membrane, an electrode slurry containing the fuel cell catalyst obtained according to Example 6 or Comparative Example 4, CNT paper sheets as gas diffusion layers (GDLs), and separators with a flow field were prepared. The electrode slurry was applied to both sides of the electrolyte membrane and then dried to form electrodes. A membrane-electrode assembly (MEA) cell was prepared by sequentially stacking the gas diffusion layers and the separators with a flow field on the electrodes.

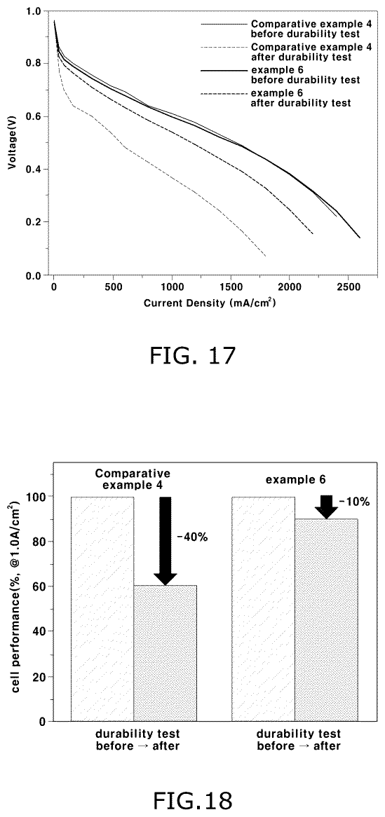

The MEA cell underwent a durability test with 10,000 cycles of charge and discharge operations under the conditions of FIG. 16. The electrochemical performance and catalyst durability deterioration rates before and after the durability test of the MEAs to which Example 6 and Comparative Example 4 are respectively applied, are shown in FIG. 17 and FIG. 18.

The cell performance evaluation results showed that the initial performance was equivalent before and after S doping. This is assumed that the performance was improved due to the increased hydrophilicity of the carbon surface due to S doping, despite some reduction in porosity.

It was observed that the deterioration rate of the S-doped carbon-loaded catalyst (Example 6) was significantly improved from 40% to 10% compared to a conventional carbon-loaded catalyst (Comparative Example 4) after an accelerated durability test inducing Pt elution. The reason is believed that the strong Pt-heteroatom bonding has an effect of reducing Pt elution and reducing particle coarsening.

What is claimed is:

1. A method of manufacturing a catalyst for a fuel cell, the method comprising:
synthesizing a precursor polymer;
preparing a carrier dispersion comprising the precursor polymer and a carbon material;
preparing an intermediate configured such that a surface of the carbon material is coated with the precursor polymer;
performing primary heat treatment on the intermediate to immobilize the precursor polymer to the surface of the carbon material;
performing secondary heat treatment on the intermediate to convert the precursor polymer to a carbonized layer, thereby producing a carbon carrier; and
synthesizing the catalyst by introducing a catalytic metal at the carbonized layer, wherein the carbonized layer comprises a heteroatom selected from the group consisting of sulfur(S), nitrogen (N), phosphorus (P), and combinations thereof.

2. The method of claim 1, wherein the precursor polymer comprises a conductive polymer.

3. The method of claim 1, wherein the synthesizing of the precursor polymer comprises:
preparing a precursor dispersion by adding a polymeric raw material and an initiator to a first organic solvent; and
performing a process in which an initiation reaction occurs from the polymeric raw material dissolved in the precursor dispersion and a polymerization reaction proceeds.

4. The method of claim 3, wherein the polymerization reaction comprises stirring the precursor dispersion, wherein the stirring is performed at a temperature in a range of 0° C. to 80° C. for a period of 3 to 48 hours.

5. The method of claim 4, further comprising washing and drying, both of which are performed after the stirring.

6. The method of claim 3, wherein the polymeric raw material comprises a material selected from the group consisting of nitrogen-containing organic materials, sulfur-containing organic materials, nitrogen-and sulfur-containing organic materials, phosphorus-containing organic materials, and polymers thereof.

7. The method of claim 6, wherein the nitrogen-containing organic materials comprise a material selected from the group consisting of pyrrole, guanine, adenine, purine, melamine, urea, pyridine, aniline, dicyandiamide, ethylenediamine, ethylenediaminetetraacetic acid (EDTA), and combinations thereof.

8. The method of claim 6, wherein the sulfur-containing organic materials comprise a material selected from the group consisting of benzyl disulfide, thiophene, 2,2-dithiophene, p-toluenesulfonic acid, 2-thiophenemethanol, and combinations thereof.

9. The method of claim 6, wherein the nitrogen-and sulfur-containing organic materials comprise a material selected from the group consisting of thiourea, ammonium thiocyanate, thioacetamide, and combinations thereof.

10. The method of claim 6, wherein the phosphorus-containing organic materials comprise a material selected from the group consisting of phytic acid, phytate, sodium hypophosphate, phosphoric acid, hexachlorophosphazene, etidronic acid, and combinations thereof.

11. The method of claim 3, wherein the initiator comprises an initiator selected from the group consisting of iron chloride (FeCl₃), ammonium persulfate ((NH₄)₂S₂O₈), zinc chloride (ZnCl₂), hydrogen peroxide (H₂O₂), potassium permanganate (KMnO₄), sodiumdichromate (Na₂Cr₂O₇), and combinations thereof.

12. The method of claim 3, wherein the precursor dispersion comprises the initiator in an amount of 0.1 to 10 equivalents.

13. The method of claim 1, wherein the carbon material comprises at least one selected from the group consisting of activated carbon, Carbon black, carbon nanotube, graphene, and combinations thereof.

14. The method of claim 1, wherein the carbon material has mesopores and wherein the mesopores have an average diameter in a range of 2 nm to 50 nm.

15. The method of claim 1, wherein the carrier dispersion is prepared by a method selected from the group consisting of ultrasonic dispersion, stirring, hydraulic high pressure homogenization, and combinations thereof.

16. The method of claim 15, wherein the hydraulic high pressure homogenization comprises:
preparing a fluid comprising the precursor polymer, the carbon material, and a second organic solvent; and
performing, at least one time, a process of adjusting a pressure of the fluid to 100 to 3,500 bar_{g} and passing the fluid through a nozzle having a diameter of 50 μm to 200 μm at a flow rate of 100 to 2,000 ml/min to disperse the carbon material.

17. The method of claim 1, wherein the intermediate comprises 100 parts by weight of the carbon material, and 30 to 150 parts by weight of the precursor polymer.

18. The method of claim 1, wherein the primary heat treatment is performed in an inert atmosphere at a temperature in a range of ±50° C. relative to a melting point of the precursor polymer for a period of 0.1 to 5 hours.

19. The method of claim 1, wherein the primary heat treatment is performed in an inert atmosphere at a temperature in a range of 200° C. to 300° C. for a period of 0.1 to 5 hours.

20. The method of claim 1, wherein the secondary heat treatment is performed at a temperature in a range of 600° C. to 1,200° C. for a period of 1 to 12 hours.

21. The method of claim 1, wherein the carbonized layer has a thickness of 3.0 nm or more.

22. The method of claim 1, wherein the carbonized layer has a longitudinal crystal size of 2.0 nm or more.

23. The method of claim 1, wherein the catalytic metal comprises a metal selected from the group consisting of platinum (Pt), gold (Au), silver (Ag), rhodium (Rh), nickel (Ni), cobalt (Co), iron (Fe), palladium (Pd), copper (Cu), iridium (Ir), osmium (Os), molybdenum (Mo), vanadium (V), and combinations thereof.

24. The method of claim 1, wherein the catalytic metal is contained in an amount of 10 to 50 parts by weight, relative to 100 parts by weight of the catalyst.

25. A fuel cell catalyst comprising:
a carbon carrier comprising a carbon material and a carbonized layer covering at least a portion of a surface of the carbon material; and
a catalytic metal uniformly dispersed at the carbonized layer,
wherein the carbonized layer comprises one heteroatom selected from the group consisting of sulfur(S), nitrogen (N), phosphorus (P), and combinations thereof.

26. The catalyst of claim 25, wherein the catalytic metal is uniformly dispersed on the carbonized layer through chemical bonding with the heteroatom.

27. The catalyst of claim 25, wherein the carbonized layer has a thickness of 3.0 nm or more.

28. The catalyst according to claim 25, wherein the carbonized layer has a longitudinal crystal size of 2.0 nm or more.

29. The catalyst of claim 25, wherein the carbon material has mesopores, wherein the mesopores have an average diameter in a range of 2 nm to 50, and wherein the catalytic metal is uniformly dispersed on an outer surface and an inner surface of the carbon material.
